(19) United States
(12) Patent Application Publication
(10) Pub. No.: US 2023/0413912 A1
(43) Pub. Date: Dec. 28, 2023

(54) AEROSOL PROVISION DEVICE

(71) Applicant: Nicoventures Trading Limited, LONDON (GB)

(72) Inventors: Daniel LOCHTMAN, London (GB); David BUREAU, London (GB); James SHERIDAN, London (GB)

(21) Appl. No.: 18/248,318

(22) PCT Filed: Oct. 12, 2021
(86) PCT No.: PCT/EP2021/078220

§ 371 Date: Apr. 7, 2023

(30) Foreign Application Priority Data
Oct. 16, 2020 (GB) 2016481.0

(51) Int. Cl. A24F 40/465; A24F 40/51; H05B 6/36; H05B 6/10

(52) U.S. Cl. CPC A24F 40/465; A24F 40/51; H05B 6/36; H05B 6/105

(57) ABSTRACT

An aerosol provision device includes a device housing having a device chamber, an induction coil for generating a varying magnetic field, and a removable receptacle arranged to be at least partially received in the device chamber; the receptacle having a base, a wall arrangement extending from the base, the base and wall arrangement defining a heating chamber arranged to removably receive at least a portion of an article including aerosol generating material, a heating element protruding into the heating chamber from the base, the heating element heatable by the induction coil for heating at least a portion of an article having aerosol generating material received in the heating chamber, and a closed channel formed within the wall arrangement, the closed channel at least partially extending in the device chamber to provide airflow to the heating chamber when the receptacle is in the device chamber.

### PRIORITY CLAIM

The present application is a National Phase entry of PCT Application No. PCT/EP2021/078220, filed Oct. 12, 2021, which claims priority from GB Application No. 2016481.0, filed Oct. 16, 2020, each of which is hereby fully incorporated herein by reference.

### TECHNICAL FIELD

The present invention relates to an aerosol provision device. The present invention also relates to an aerosol provision system comprising the aerosol provision device and an article comprising aerosol generating material, a kit of parts including the aerosol provision device and a method of using the aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device comprising a device housing having a device chamber, a removable receptacle arranged to be at least partially received in the device chamber; the receptacle comprising a base, a wall arrangement extending from the base, the base and wall arrangement defining a heating chamber arranged to removably receive at least a portion of an article comprising aerosol generating material, a heating element for heating at least a portion of an article comprising aerosol generating material received in the heating chamber, wherein the receptacle has a closed channel within the wall arrangement, the closed channel within the wall arrangement being at least partially received within the device chamber when the receptacle is received within the device chamber to provide airflow to the heating chamber.

In an embodiment of the above, the heater element protrudes into the heating chamber from the base.

In a further embodiment of any of the above, the receptacle defines an axis, and the closed channel extends in the axial direction.

In a further embodiment of any of the above, the aerosol provision device comprises an opening to the heating chamber at a proximal end of the receptacle, and wherein the base is at a distal end of the receptacle, and wherein the closed channel extends between the distal and proximal ends.

In a further embodiment of any of the above, the closed channel comprises an air inlet at the proximal end extending in the radial direction.

In a further embodiment of any of the above, the air inlet extends around the opening.

In a further embodiment of any of the above, the closed channel comprises an air outlet to the heating chamber.

In a further embodiment of any of the above, the air outlet is proximate to the base.

In a further embodiment of any of the above, the air outlet extends in a radial direction.

In a further embodiment of any of the above, the wall arrangement comprises an outer wall and an inner wall, wherein the closed channel is formed between the outer wall and inner wall.

In a further embodiment of any of the above, the outer wall extends from the base.

In a further embodiment of any of the above, the outer wall and the base form a cup.

In a further embodiment of any of the above, the cup forms a fluid barrier.

In a further embodiment of any of the above, an air outlet is formed in the inner wall.

In a further embodiment of any of the above, the air outlet is annular around the inner wall.

In a further embodiment of any of the above, the inner wall is removably mounted in the outer wall.

In a further embodiment of any of the above, the outer wall and the base are integrally formed.

In a further embodiment of any of the above, an interior of the inner wall defines the heating chamber.

In a further embodiment of any of the above, the air outlet is between the base and the inner wall.

In a further embodiment of any of the above, the receptacle comprises a plurality of closed channels.

In a further embodiment of any of the above, the aerosol provision device comprises ribs which secure the inner wall to the outer wall, the ribs extending axially along the inner wall and defining a plurality of closed channels between the outer wall and the inner wall.

In a further embodiment of any of the above, the closed channel is annular and extends circumferentially around the inner wall.

In a further embodiment of any of the above, the aerosol provision device comprises a thermal sensor configured to be in thermal communication with the heating element when the heating assembly is secured to the device.

In a further embodiment of any of the above, the thermal sensor is a thermocouple.

In a further embodiment of any of the above, the aerosol provision device comprises a plate which thermally connects the heating element to the thermal sensor.

In a further embodiment of any of the above, the plate is connected to the heating assembly such that the plate is removable from the device with the heating assembly.

In a further embodiment of any of the above, the plate is connected to the device such that the heating assembly is removable from the plate and the device.

In a further embodiment of any of the above, the heating element is removably secured to the base.

In a further embodiment of any of the above, the heating assembly is configured such that rotation of the base relative to the device allows the heating assembly to be secured to or removed from the device.

In a further embodiment of any of the above, the device and the heating assembly comprise complementary interlocking features that are configured to engage in response to rotation of the base relative to the device.

In a further embodiment of any of the above, the heating element comprises a susceptor, and the device comprises at least one inductive coil arranged to energize the susceptor to heating.

In a further embodiment of any of the above, the at least one inductive coil comprises two inductive coils which are separately energizable.

According to an aspect of the present disclosure, there is provided a system comprising the aerosol provision device of any of the above, and a removable article received within the heater assembly of the device.

According to an aspect of the present disclosure, there is provided a removable insert for an aerosol provision device, the insert comprising a receptacle defining a heating chamber arranged to removably receive at least a portion of an article comprising aerosol generating material, and a heating element for heating at least a portion of an article comprising aerosol generating material received in the heating chamber, wherein the receptacle comprises an opening at a proximal end, a base at a distal end, and a wall arrangement extending between the proximal and distal ends, wherein a closed channel is defined within the wall arrangement to provide airflow along the wall arrangement.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a perspective view of an example of an aerosol provision device;

FIG. 2 shows a cross-sectional front view of the aerosol provision device of FIG. 1;

FIG. 3 shows a close up of part of FIG. 2;

FIG. 4A shows a perspective view of the heater assembly in isolation from the rest of the device;

FIG. 4B shows a cross-sectional view of the heater assembly of FIG. 4A;

FIG. 5 shows a top view of the device with the heater assembly of FIGS. 4A and 4B inserted into the device housing;

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

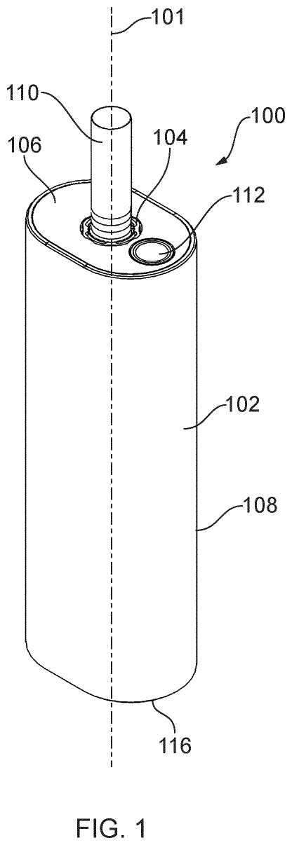

FIG. 1 shows an example of an aerosol provision device 100 for generating aerosol from an aerosol generating medium/material. In broad outline, the device 100 may be used to heat a replaceable article 110, also known as a consumable, comprising the aerosol generating medium, to generate an aerosol or other inhalable medium which is inhaled by a user of the device 100.

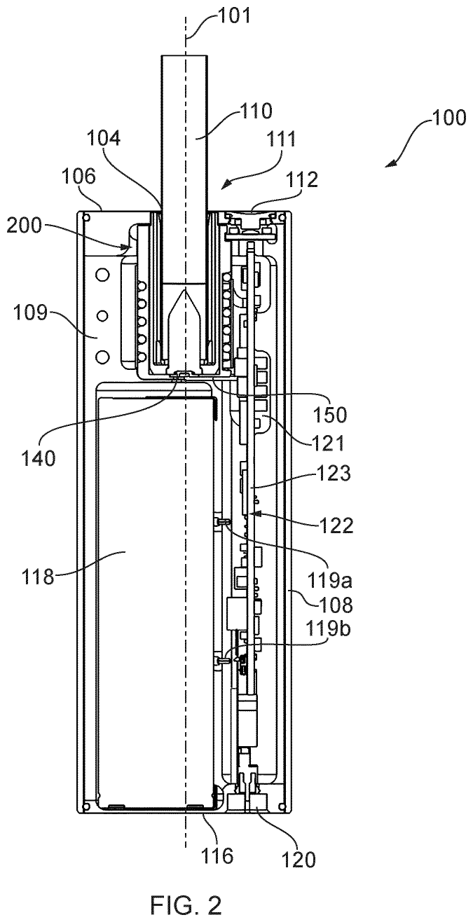

The device 100 comprises a housing 102 (including an outer cover 108) which surrounds and houses various components of the device 100. The device 100 has an opening 104 in one end, through which the article 110 may be inserted for heating by a heater assembly 200 (refer to FIG. 2). In use, the article 110 may be fully or partially inserted into the heater assembly 200 where it may be heated by one or more components of the heater assembly 200.

The device 100 may also include a user-operable control element 112, such as a button or switch, which operates the device 100 when pressed. For example, a user may turn on the device 100 by operating the switch 112.

The device 100 defines a longitudinal axis 101.

FIG. 2 depicts a schematic cross-sectional front view of the device 100 of FIG. 1. The device 100 comprises the outer cover 108, a first end member 106 and a second end member 116. The device 100 includes a chassis 109, a power source 118, and an aerosol generating assembly 111 including the heater assembly 200. The device 100 further comprises at least one electronics module 122.

The outer cover 108 forms part of a device shell. The first end member 106 is arranged at one end of the device 100 and the second end members 116 is arranged at an opposite end of the device 100. The first and second end members 106, 116 close the outer cover 108. The first and second end members 106, 116 form part of the shell. The device 100 in embodiments comprises a lid (not shown) which is moveable relative to the first end member 106 to close the opening 104 when no article 110 is in place.

The device 100 may also comprise an electrical component, such as a connector/port 120, which can receive a cable to charge a battery of the device 100. For example, the connector may be a charging port, such as a USB charging port. In some examples the connector may be used additionally or alternatively to transfer data between the device 100 and another device, such as a computing device.

The device 100 includes the chassis 109. The chassis 109 is received by the outer cover 108. The aerosol generating assembly 111 comprises the heater assembly 200 into which, in use, the article 110 may be fully or partially inserted where it may be heated by one or more components of the heater assembly 200. The aerosol generating assembly 111 and the power source 118 are mounted on the chassis 109. The chassis 109 is a one piece component.

One-piece component refers to a component of the device 100 which is not separable into two or more components following assembly of the device 100. Integrally formed relates to two or more features that are formed into a one piece component during a manufacturing stage of the component.

The first and second end members 106, 116 together at least partially define end surfaces of the device 100. For example, the bottom surface of the second end member 116 at least partially defines a bottom surface of the device 100. Edges of the outer cover 108 may also define a portion of the end surfaces. The first and second end members 116 close open ends of the outer cover 108. The second end member 116 is at one end of the chassis 109.

The end of the device 100 closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The power source 118 is, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generating assembly 111 to supply electrical power when required and under control of a controller 121 to heat the aerosol generating material.

The power source 118 and aerosol generating assembly 111 are disposed in an axial arrangement, with the power source 118 at the distal end of the device 100 and the aerosol generating assembly 111 at the proximal end of the device 100. Other configurations are anticipated.

The electronics module 122 may comprise, for example, a printed circuit board (PCB) 123. The PCB 123 may support at least one controller 121, such as a processor, and memory. The PCB 123 may also comprise one or more electrical tracks to electrically connect together various electronic components of the device 100. For example, the battery terminals 119a, 119b may be electrically connected to the PCB 123 so that power can be distributed throughout the device 100. The connector 120 may also be electrically coupled to the battery 118 via the electrical tracks.

The aerosol generating assembly 111 is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

A temperature sensor 150, for example a thermocouple, is in thermal communication with the susceptor, and is connected to the electronics module 122. In the depicted embodiment, a thermally conductive plate 140 is placed between the thermocouple 150 and the susceptor to facilitate thermal communication between the thermocouple 150 and the susceptor

The thermocouple 150 monitors the temperature of the susceptor during use of the device 100 and feeds this information to the electronics module 122. This allows the electronics module 122 and the controller 121 to monitor and adjust the temperature of the susceptor as may be necessary during use of the device 100, e.g. by adjusting the amount of electrical power supplied by the power source 118. The thermocouple 150 can be any suitable thermocouple, such as a platinum rhodium thermocouple (i.e. B type).

Compared to other devices for sensing temperature, the thermocouple 150 may facilitate more robust, durable, power-efficient and accurate temperature measurements. Nonetheless, in other examples within the scope of this disclosure, the temperature sensor can be any other suitable temperature sensor, such as a resistance temperature detector, thermistor, infra-red sensor etc.

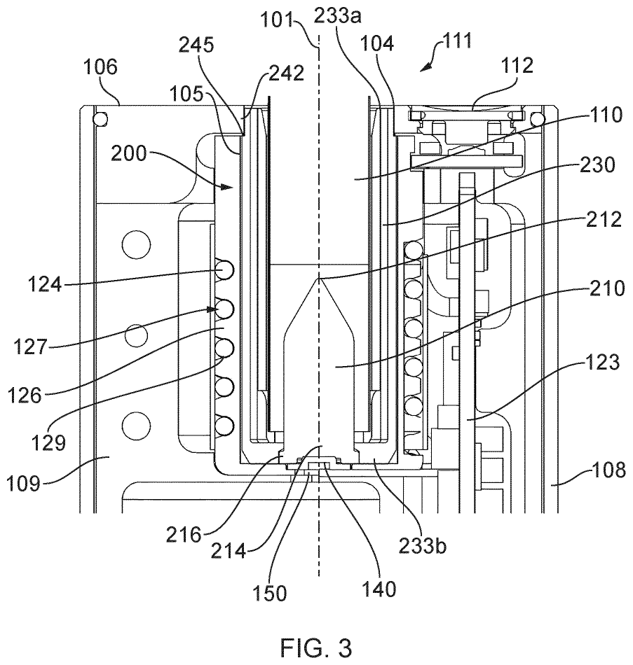

FIG. 3 shows a close up view of part of the aerosol generating assembly 111 in cross-section that includes the heater assembly 200 and an inductor coil assembly 127.

The aerosol generating assembly 111 comprises the inductor coil assembly 127 and the heater assembly 200. The inductor coil assembly 127 extends around the heater assembly 200. The inductor coil assembly 127 comprises a coil support 126. The inductor coil assembly 127 includes an inductor coil 124 wrapped around (i.e. surrounding) the heater assembly 200, disposed in a groove 129 defined in the support 126. The inductor coil assembly 127 is fixedly mounted in the device housing 102. The coil support 126 may form part of the device housing 102.

The heater assembly 200 includes a heating element 210 for heating the article 110 during use. In the exemplified embodiment of FIG. 3, the heating element is a susceptor arrangement 210 (herein referred to as “a susceptor”). In other examples, the heating element could be of another type, for example a resistive heater. The susceptor 210 of this example is a blade-shaped susceptor 210. The article 110 can be inserted onto or around the susceptor 210. The blade-shaped susceptor 210 may have a constant rectangular cross-section along the majority of its axial length and then taper to a blade tip 212. In other examples, the axial cross-section may vary along the axial length of the susceptor 210 to the blade tip 212.

Although a blade-shaped susceptor 210 is depicted, it is to be understood that any other suitable shape or form of susceptor 210 may be used within the scope of this disclosure. For example, the susceptor 210 could be pin-shaped e.g. with a constant circular cross-section along its axial length that tapers to a pin tip, or rod-shaped (e.g. a cylindrical rod or a square rod) with a constant or varying cross-section along its axial length that omits a tip or tapered portion. In further examples, the susceptor 210 may be a tubular member within which the article 110/aerosol generating material is received. Such a susceptor is an outer susceptor. In such an example, the susceptor may define a peripheral wall (e.g. an annular wall) that defines at least part of a heating chamber within which the article 110 can be received and heated. In such an example, the susceptor surrounds the article 110, instead of the article 110 surrounding the susceptor as in the blade-shaped embodiment discussed above. It will be understood that the cross-sectional profile of the outer susceptor may be formed in a variety of profile shapes.

In further examples, multiple susceptors (e.g. two or more separate susceptors) may also be provided, and may be of differing or similar configurations (e.g. pin-shaped, blade-shaped, rod-shape or tubular-type etc.), as required.

The susceptor 210 is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may therefore be heatable by electrical resistance. The heater assembly 200 may therefore comprise electrical contacts for electrical connection with the apparatus for electrically activating the heating element by passing a flow of electrical energy through the heating element. In such embodiments, inductive coil assembly 127 can be omitted as appropriate.

The inductor coil 124 is made from an electrically conducting material. In this example, the inductor coil 124 is made from Litz wire/cable which is wound in a helical fashion to provide a helical inductor coil 124. Litz wire comprises a plurality of individual wires which are individually insulated and are twisted together to form a single wire. Litz wires are designed to reduce the skin effect losses in a conductor. In the example device 100, the inductor coil 124 is made from copper Litz wire which has a circular cross section. In other examples the Litz wire can have other shape cross sections, such as rectangular. The inductor coil 124 can be connected to the PCB 123 to control the activation of inductive heating therefrom using the electronics module 122 and switch 112.

The number of inductor coils used may also differ. For example, although the heater assembly 200 shown in FIG. 3 includes an inductor coil assembly 127 with only a single coil 124, it should be understood that the inductor coil assembly 127 can feature any number of suitable coils. Additional coils may be used to provide different heating zones with different heating characteristics for the susceptor 210 (e.g. provide different heating conditions to different areas along the axial length of the susceptor 210 and/or provide different heating conditions to the susceptor 210 at different times or for different use cases). Additional coils may also be provided to generate heating in additional susceptors that may be disposed in the heater assembly 200 (not shown).

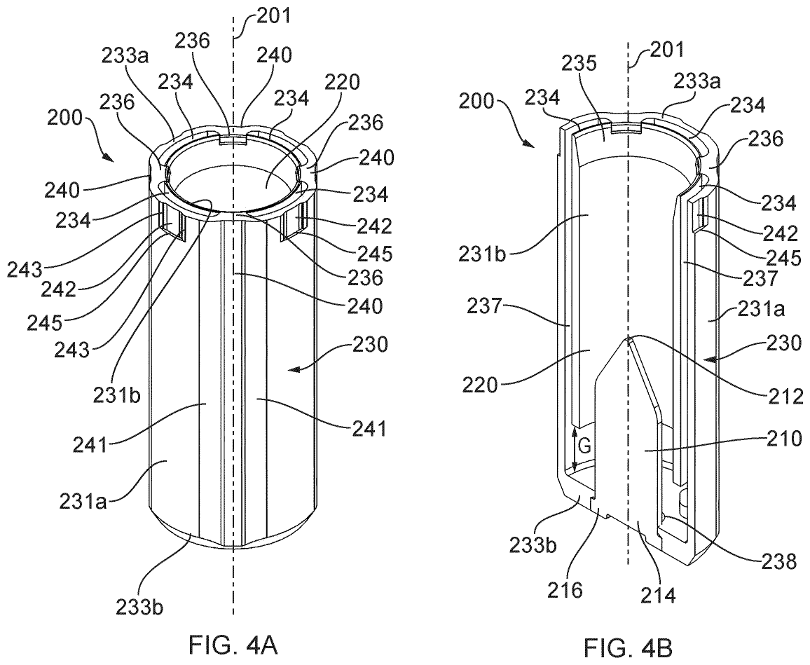

The heater assembly 200 also includes a receptacle 230 (shown in more detail in FIGS. 4A and 4B). The receptacle 230 defines a heating chamber 220 within which the article 110 is received during use. In the depicted embodiment, the receptacle 230 is an annular body that encircles the susceptor 210 and provides an annular space between the susceptor 210 and the receptacle within which the article 110 can be received and heated during use.

The coil support 126 and opening 104 define a device chamber 105 within the device housing 102 that receives the receptacle 230 and interacts therewith in order to secure the heater assembly 200 in place. In embodiments, the device chamber 105 is defined by another feature other than the coil support 126. The coil support 105 forms an internal wall. The internal wall is cup shaped.

The receptacle 230 is removably disposed within the chamber 105, such that it can be removed therefrom and replaced therein during use. This feature facilitates the cleaning of the receptacle 230 (and other heater assembly components part thereof), as well as replacement of the receptacle 230 (and other heater assembly components part thereof) in the event of breakage or failure.

In the depicted example, the receptacle 230 is completely disposed inside the chamber 105. In other examples, when the receptacle 230 is received in the chamber 105 a portion of the receptacle 230 (e.g. such as a lip or a flange at its proximal end) may still extend outside of the device chamber 105. In such examples, the receptacle 230 may therefore be ‘partially removably disposed’ in the chamber 105. This disclosure covers all such examples.

FIGS. 4A and 4B show the heater assembly 200 and the receptacle 230 in more detail. The receptacle 230 includes annular outer and inner walls 231a, 231b that are concentric with each other about the longitudinal axis 201 of the heater assembly 200. The outer wall 231a forms an outer shell. The inner wall 231b forms an inner shell. As shown in FIGS. 2 and 3, when the heater assembly 200 is inserted into the device housing chamber 205, the longitudinal axis 201 of the heater assembly 200 is substantially co-axial with the longitudinal axis 101 of the device 101.

The outer wall 231a extends axially from an opening/inlet end 233a to an opposing base 233b of the receptacle 230. The outer wall 231a may define the base 233b itself, and be integrally formed therewith. Alternatively, the base 233b could be attached to the outer wall 231a separately. The outer wall 231a forms a cup. The opening/inlet end 233a is so called, because it is the end of the heater assembly 200 that sits in the inlet 104 of the device 100 when the receptacle is inserted into the device housing chamber 105. Accordingly, as discussed above in relation to the device 100, the opening/inlet end 233a may also be referred to as the proximal end (or mouth end) of the heater assembly 200, whilst the base 233b may be referred to as the distal end of the heater assembly 200.

The base 233b defines an aperture 238 therein within which the heating element 210 is received and protrudes (axially) therefrom. The heating element 210 defines a base 214 and an anchoring flange 216 around the base 214 that is received in the aperture 238. The anchoring flange 216 and base 214 may be press-fit into the aperture 218. However, any other suitable method of securing the heating element 210 in place in the receptacle 230 may be used e.g. insert molding, interference fit, threaded fitment etc. In embodiments, aperture 238 could instead be a blind cavity/recess or may be omitted completely depending on the securing method used to attached the heating element 210 in place in the receptacle 230.

The heating element 210 is fixedly attached to the receptacle 230, such that it is a part of the receptacle 230 itself and is supported thereby. In this manner, the heating element 210 is removable from the device housing chamber 105, with and as part of the receptacle 230.

The heating element 210 forms a fluid-tight seal with the base 233b of the receptacle 230, such that the base 233b of the receptacle 230 is not permeable to fluids. The heating chamber 220 is thereby made fluid-tight at the distal end thereof. Any residue or condensate byproducts which are created during the aerosolisation process are therefore confined to the receptacle 230, where they gather at the base 233b. The receptacle 230 can then be removed from the device 100 and cleaned or replaced, without the device 100 being exposed to the residue or condensate, which could otherwise cause damage to internal components of the device 100.

In the embodiment shown, the outer wall 231a and the base 233b of the receptacle 230 together form a cup, which defines a fluid-tight heating chamber 220, providing further protection of the device 100 by limiting the residue and condensate which the interior of the device 100 is exposed to. In the embodiment shown, the outer wall 231a and the base 233b are integrally formed to provide the cup and the fluid-tight heating chamber 220.

In embodiments where the device 100 is provided with a thermocouple 150 or other thermal sensor, a plate 140 may be provided to thermally connect the heating element 210 and the thermocouple 150 (as discussed above in relation to FIG. 3). The plate 140 may form part of the receptacle 230, and be removable therewith. On insertion of the receptacle 230 into the device 100, the plate 140 engages with the thermocouple 150 for thermal communication therewith. Alternatively, the plate may form part of the device 100, and on insertion of the receptacle 230 into the device 100, a bottom of the heating element 210 engages with the plate 140 for thermal communication therewith.

The heating element 210 may additionally be separately removable from the receptacle 230 itself. For example, the heating element 210 could be removably fixed to the receptacle 230 instead of fixedly attached thereto. For example, by being threadably received therein, being received by a bayonet fitting therein, or using connectors on the heating element 210 that interference fit with corresponding connectors which can be pulled apart.

This may facilitate cleaning and/or replacement of the heating element 210. This improvement in replacement of the heating element 210 may be useful in the event that the heating element 210 is broken or has failed and needs to be replaced without replacement of the entire receptacle 230, or where the receptacle 230 needs to be replaced by the heating element 210 is still usable with a new receptacle but the removability may also be useful for interchanging different heating elements 210 for different use cases; for example, when a certain use case or article 110 may demand a different shape/type of heating element 210 to another.

The inner wall 231b extends axially from the proximal end 233a towards the base 233b but does not connect to the base 233b. The inner wall 231b stops axially short of the base 233b to form an axial gap G, or air outlet, proximate the base, and between the inner wall 231b and the base 233b. In the depicted example, the axial gap G provides an annular gap around the heating element 210 between the base 233b and the inner wall 231b.

The inner wall 231b features a tapered surface 235 at the proximal end 233a. The tapered surface 235 tapers at an angle towards the longitudinal axial 201 from the proximal end 231b. The tapered surface 235 may help facilitate insertion of the article 110 into the heater assembly 200 and heating chamber 220. For example, it may facilitate correct alignment of the article 110 when it is insert into the heating chamber 220 around the heating element 210.

The outer wall 231a and inner wall 231b are spaced radially apart and are, for example, connected by radially extending ribs 236. The ribs 236 secure the inner wall 231b in place within the outer wall 231a. There are a discrete number of ribs 236 disposed between the outer and inner walls 231a, 231b around the circumference of the walls 231a, 231b. In the illustrated example, there are four such ribs 236 spaced equally around the circumference of the walls 231a, 231b. However, any suitable number and spacing of ribs 236 can be used.

In other examples, the outer and inner walls 231a, 231b could be connected by other means, for example by pin connections which allow a nearly continuous space between the outer and inner walls 231a 231b for airflow in, for example, a single, substantially annular passage or channel.

In the depicted embodiment, the ribs 236 extend axially along the whole of the length of the inner wall 231b. However, the ribs 236 may extend any suitable axial distance between the walls 231a, 231b that is sufficient to provide the required support for holding the walls 231a, 231b concentrically in place relative to each other.

The combination of the outer wall 231a, inner wall 231b and ribs 236 define slots 234, or air inlets, at the proximal end 233a and form passages 237 or channels that extend axially within the receptacle 230. The passages or channels are closed; that is, they comprise an inlet and an outlet and a fluidly-isolated section between the inlet and outlet, such that air is passed from the inlet to the outlet. The fluidly-isolated section is fluidly isolated from the heating chamber 220 and from an exterior of the receptacle 230, except from at the inlet and the outlet.

The number and size of slots 234 and passages 237 can be varied as necessary depending on the size, spacing and number of ribs 236. Moreover, the slots 234 and passages 237 needn't be defined at the proximal end 233a. For example, the ribs 236 could be present at any suitable axial location within the receptacle 230, e.g. nearer the base 231b or midway along the axial length of the walls 231a, 231b. Moreover, the slots 234 and passages 237 could instead provide a single (e.g. substantially annular, and extending around substantially the whole circumference of the inner wall) slot 234/passage 237 that extends axially between the inner and outer walls 231a, 231b.

The passages 237 are used as airflow passages that permit the communication of airflow from the exterior of the device 100 to the heating chamber 220 and the aerosol generating materials therein during use. The inlet of airflow from the proximal end 233a via slots 234 and passages 237 is convenient, as the user is unlikely to block airflow to such a region when using the device 100.

The passages 237 exit into the annular space provided by gap G, or air outlet, which in use allows airflow to be communicated from the passages 237 into the heating chamber 220, and through the aerosol generating material/article 110 therein.

The presence of passages 237 between the inner and outer walls 231a, 231b can allow for improved control of the airflow and resistance to airflow through the passages 237. For example, it may allow the use of airflow modifying features (e.g. airflow constrictors) to be placed in the passages 237 (e.g. extending between walls 231a, 231b and/or from ribs 236) in order to provide a more consistent airflow and/or desirable airflow resistance to be communicated through the article 110 and to the user in use.

The device 100 and/or heater assembly 200 could provide additional arrangements of airflow passages for supplying airflow for use of the device 100. For example, airflow passage(s) could also be provided in the side of the device, or defined between the inner wall 231b and the article 110 itself. Airflow passage(s) could also be directed from the distal end of the device 100 and up through the base 233b instead or in addition.

The outer and inner wall 231a, 231b configuration of the receptacle 230 can facilitate improvements in the amount of insulation provided between the heating element 210 and the device housing 102 (e.g. compared to a single-walled receptacle 230). The passages 237, used as airflow passages, may facilitate yet further improvement in the amount of insulation provided between the heating element 210 and the device housing 102 (e.g. as the (relatively cool external) airflow can absorb excess heat from the inner and outer walls 231a, 231b). The amount of insulation provided by the heater assembly 200 can be an important consideration for the device 100, as it may be necessary to prevent the device 100 becoming too hot in the user's hand or the temperatures becoming troublesome for other device components. By providing an air gap in the receptacle 230, it is possible to facilitate an improvement in the amount of insulation required in the device housing, leading to a compact device housing.

As discussed in the passage above, the receptacle 230 is removably disposed within the chamber 105, such that it can be removed therefrom and replaced therein during use. In being removable, the receptacle 230 may also be replaced by a receptacle with a different configuration, for example with a different configuration of air passages. This may provide for customizability of the device 100 for consumer benefit, or for interaction with different consumables.

In particular, in the depicted embodiments, the receptacle 230 is configured to interact with the chamber 105 in such a way that rotation of the receptacle 230 relative to the device housing 102 allows it to be engaged and disengaged in response to rotation of the receptacle 230.

The receptacle 230 and the device housing 102 include complementary interlocking features that are configured to engage or disengage in response to rotation of the receptacle 230 relative to the device housing 102.

Within the context of this disclosure, it should be understood that ‘engage’ relates to an engagement that holds the receptacle 230 in place sufficiently in the device housing 102 for use of the device 100, and ‘disengage’ relates to the releasing of such an engagement that allows the receptacle 230 to be removed from the device housing 102 (e.g. without having to remove other components of the device housing 102 or destroying parts of the device housing 102).

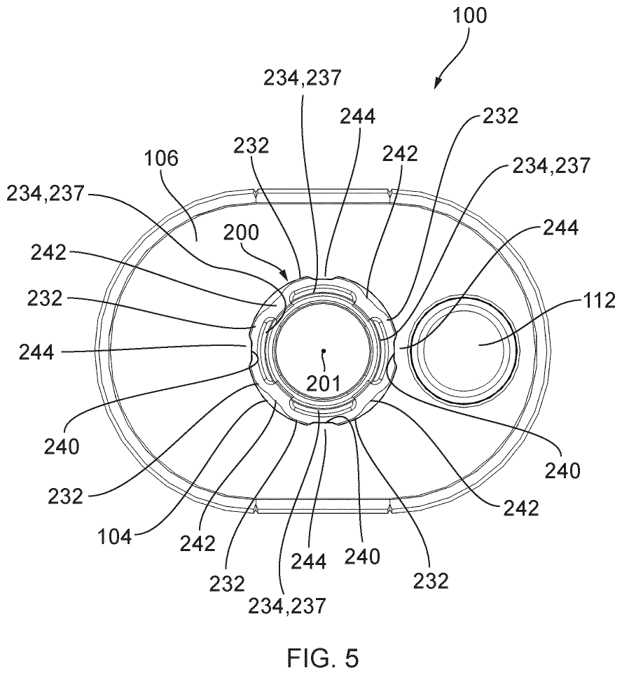

As shown in FIGS. 4A, 4B and 5, the complementary interlocking features are provided by grooves 240, 242 (or recesses) on an outer surface 232 of the receptacle 230 (i.e. radially outward facing surface of the outer wall 231a) and corresponding protrusions 244 on the device housing 102. The protrusions 244 extend radially inward from an inner surface of the device housing chamber 105 relative to the longitudinal axis 101 of the device 100.

As best shown in FIG. 5, when the heater assembly 200 is inserted into the device housing chamber 105 it is done so with the protrusion 244 radially aligned with the groove 240 (i.e. relative to longitudinal axis 201). Protrusion 244 and groove 240 are sized such that the protrusion 244 does not ‘engage’ (as discussed above) the receptacle 230 when inserted in the groove 240.

When the heater assembly 200 is subsequently rotated about the longitudinal axis 201 relative to the device housing 105, the protrusion 244 is rotated out of radial alignment with groove 240, across the outer surface 232, and into radial alignment with groove 242. Protrusion 244 and groove 242 are sized and shaped such that the protrusion 244 ‘engages’ the receptacle 230 when inserted in the groove 242. This engagement can be provided by a sufficient interference fit/contact being made between the protrusion 244 and groove 242. For example, the grooves 242 define a ridge 245 that extends radially from the groove 242 to meet the outer surface 232. When the protrusions 244 are aligned in the grooves 242 they are axially above the ridge 245 and radially overlap the ridge 245. If the receptacle 230 should try to be removed from the device housing chamber 105 with the protrusion 244 in this position (e.g. pulled out from the chamber 105 along the longitudinal axis 101), the ridge 245 will provide interfering contact with the protrusion 244 to prevent its removal.

It will be understood that subsequently rotating the receptacle 230 out of radial alignment with the groove 242/ridge 245 and back into radial alignment with the groove 240 will result in the receptacle 230 being ‘disengaged’ from the protrusion 244 and thus the device housing 102. This allows subsequent removal of the receptacle 230 from the chamber 105 and device housing 102.

The grooves 240, 242 can feature tapered/contoured surfaces 241, 243 which, along with the outer surface 232 and the protrusions 244, can be shaped/contoured as required to provide a particular resistance to rotation between grooves 240, 242. Moreover, the shape, (radial) depth and (axial) height of the grooves 242 and corresponding (radial and axial) lengths of the protrusion 244 can also be used to vary the degree of engagement between the receptacle 230 and the device housing 102 (e.g. by adjusting the degree of the interference fit/contact between the protrusion 244 and grooves 242 and ridges 245 in the engaged position) and associated resistance to rotation provided thereby.

Tailoring the resistance to rotation and degree of engagement in this manner can not only be used to ensure the heater assembly 200 is sufficiently held in the engaged position for use, but that it is also easy enough to rotate to the disengaged position to facilitate removal. Tailoring of these features can also be used to improve the user's perceived ‘smoothness’ and/or ‘quality’ of the rotation and removal process of the heater assembly 200.

Although four sets of grooves 240, 242 and protrusions 244 are shown spaced around the circumference of the chamber 105 and the heater assembly 200, any suitable number and spacing could be used within the scope of this disclosure.

In the depicted example, the grooves 240 extend the full axial length of the outer wall 231a (i.e. from proximal end 233a to base 233b). This can facilitate ensuring the correct axial and radial alignment of the heater assembly 200 during insertion into the device housing 102, as protrusions 244 can be easily aligned and guided along the grooves 240 during the insertion process.

The grooves 240 are also shown radially aligned with the ribs 236 relative to the longitudinal axis 202. This may give the grooves 240 additional structural support to resist bending during insertion of the heater assembly 200. However, the grooves 240 need not be placed in such a position, and can be positioned any other suitable radial position.

The protrusions 244 and grooves 242 are depicted at the inlet 104 and the proximal end 231a. However, within the scope of this disclosure the protrusions 244 and/or grooves 242 can be placed at any suitable axial position within the chamber 105 and along the outer surface 232, respectively. The axial length and positioning of the grooves 240 can also be varied accordingly.

Although in the depicted example the grooves 240, 242 are disposed on the receptacle 230 and the protrusions 244 disposed on the device housing 102, within the scope of this disclosure, the grooves 240, 242 could alternatively be disposed on the device housing 102 (i.e. in the chamber 105) and the protrusions 244 disposed on the receptacle 230 instead.

Although one particular set of complementary interlocking features to achieve the removable rotation engagement between the receptacle 230 and the device housing 102 in the form of grooves 240, 242 and protrusions 246 has been depicted and explained above, the present disclosure extends to any other suitable implementation of such rotational complementary interlocking features.

In one example, the complementary interlocking features could be complementary threaded portions disposed on the receptacle 230 (e.g. on the outer surface 232) and within the chamber 105. In such an example, the receptacle 230 could be screwed into and out of engagement with the device housing 102 via rotation thereof relative to the device housing 102.

In another example, the complementary interlocking features could provide a bayonet fitting type rotational engagement. In such an example, the receptacle 230 could feature radially extending pins on the outer surface 232 that can be received in corresponding L-shaped slots or recesses provided in the chamber 105. Alignment and rotation of the pins in the L-shaped slots would secure them in place to ‘engage’ the receptacle 203 to the device housing 102 (commonly known as a bayonet fitting). The L-shaped slots and pins could also alternatively be provided on the receptacle 230 and chamber 105, respectively, instead.

In any of the above discussed rotational engagement examples, a biasing member, such as a spring (not shown), could be supplied within the chamber 105/device housing 102. The biasing member can be configured to be compressed in response to insertion of the receptacle 230 into the device housing chamber 105 (e.g. by the base 233b) to provide a biasing force that opposes the insertion (but that does not override the engagement, when the receptacle 230 is placed into the engaged position within the housing 102).

Such a biasing member and force may be used to facilitate subsequent removal of the receptacle 230 from the housing 102 as it may help urge the receptacle 230 out of the chamber 105 when it is disengaged from the housing 102. It may also help provide suitable resistance to insertion of the receptacle 230 into the housing 102 to improve the user's perceived ‘smoothness’ and/or ‘quality’ of the insertion and removal process of the receptacle 230.

1. An aerosol provision device comprising:
a device housing having a device chamber;
a removable receptacle arranged to be at least partially received in the device chamber; the receptacle comprising:
a base;
a wall arrangement extending from the base, the base and wall arrangement defining a heating chamber arranged to removably receive at least a portion of an article comprising aerosol generating material;
a heating element for heating at least a portion of an article comprising aerosol generating material received in the heating chamber;
wherein the receptacle has a closed channel within the wall arrangement, the closed channel within the wall arrangement being at least partially received within the device chamber when the receptacle is received within the device chamber to provide airflow to the heating chamber.

2. The aerosol provision device of claim 1, wherein the heater element protrudes into the heating chamber from the base.

3. The aerosol provision device of claim 1, wherein the receptacle defines an axis, and the closed channel extends in the axial direction.

4. The aerosol provision device of claim 3, comprising an opening to the heating chamber at a proximal end of the receptacle, and wherein the base is at a distal end of the receptacle, and wherein the closed channel extends between the distal and proximal ends.

5. The aerosol provision device of claim 4, wherein the closed channel comprises an air inlet at the proximal end extending in the radial direction.

6. The aerosol provision device of claim 5, wherein the air inlet extends around the opening.

7. The aerosol provision device of claim 1, wherein the closed channel comprises an air outlet to the heating chamber.

8. The aerosol provision device of claim 7, wherein the air outlet is proximate to the base.

9. (canceled)

10. The aerosol provision device of claim 1, wherein the wall arrangement comprises an outer wall and an inner wall, wherein the closed channel is formed between the outer wall and inner wall.

11. The aerosol provision device of claim 10, wherein the outer wall extends from the base, wherein the outer wall and the base form a cup.

12. (canceled)

13. (canceled)

14. The aerosol provision device of claim 10, wherein an air outlet is formed in the inner wall.

15. The aerosol provision device of claim 14, wherein the air outlet is annular around the inner wall.

16. The aerosol provision device of claim 10, wherein the inner wall is removably mounted in the outer wall.

17-18. (canceled)

19. The aerosol provision device of claim 10, wherein the air outlet is between the base and the inner wall.

20. The aerosol provision device of claim 1, wherein the receptacle comprises a plurality of closed channels.

21. The aerosol provision device of claim 20, comprising ribs which secure the inner wall to the outer wall, the ribs extending axially along the inner wall and defining a plurality of closed channels between the outer wall and the inner wall.

22. (canceled)

23. The aerosol provision device of claim 1, comprising a thermal sensor configured to be in thermal communication with the heating element when the heating assembly is secured to the device.

24. (canceled)

25. The aerosol provision device of claim 23, comprising a plate which thermally connects the heating element to the thermal sensor.

26. The aerosol provision device of claim 25, wherein the plate is connected to the heating assembly such that the plate is removable from the device with the heating assembly.

27. (canceled)

28. The aerosol provision device of claim 1, wherein the heating element is removably secured to the base.

29. The aerosol provision device of claim 28, wherein the heating assembly is configured such that rotation of the base relative to the device allows the heating assembly to be secured to or removed from the device.

30-32. (canceled)

33. A system comprising: the aerosol provision device of claim 1; and
a removable article received within the heater assembly of the device.

34. A removable insert for an aerosol provision device, the insert comprising:
a receptacle defining a heating chamber arranged to removably receive at least a portion of an article comprising aerosol generating material; and
a heating element for heating at least a portion of an article comprising aerosol generating material received in the heating chamber;
wherein the receptacle comprises an opening at a proximal end, a base at a distal end, and a wall arrangement extending between the proximal and distal ends, wherein a closed channel is defined within the wall arrangement to provide airflow along the wall arrangement.
